(19) United States
(12) Patent Application Publication
(10) Pub. No.: US 2013/0132296 A1
(43) Pub. Date: May 23, 2013

(54) NETWORKED BUSINESS OBJECT SHARING

(71) Applicant: Norbert Manfred Koppenhagen, Weinheim (DE)

(72) Inventor: Norbert Manfred Koppenhagen, Weinheim (DE)

(21) Appl. No.: 13/299,138

(22) Filed: Nov. 17, 2011

(51) Int. Cl. G06Q 10/00

(52) U.S. Cl. 705/342

(57) ABSTRACT

A method may include acquiring metadata defining a networked business object, the networked business object model being a meta model class or type data structure and the acquiring including acquiring first state metadata defining a first set of attributes to associate with a first state of the networked business object class; acquiring second state metadata defining a second set of attributes to associate with a second state of the networked business object; and creating the object model having a plurality of states by associating the first set of attributes and the second set of attributes with each other.

### FIELD

Some embodiments relate to business objects supported by a business process platform. More specifically, some embodiments relate to the creation of a networked business object that may be shared by a plurality of networked entities.

### BACKGROUND

A business object is a software model representing real-world items used during the transaction of business. For example, a business object may represent a business document such as a sales order, a purchase order, or an invoice. A business object may specify business logic and/or data having any suitable structure. The structure of a business object may be determined based on the requirements of a business scenario in which the business object is to be deployed. A business solution for a particular business scenario may include many business objects, where the structure of each business object has been determined based on the requirements of the particular business scenario.

Conventional business practices and processes typically depend on an on-going exchange of business documents to implement the business processes. In typical fashion, each step of the business process is negotiated and agreed upon by the business partners and further memorialized in a document or record. The reliance on the creation and exchange of different documents, including documents of different versions, increases the costs of doing business and in some instances is not very efficient.

Accordingly, a method and mechanism for effectively representing business scenarios and solutions are desired, and may be provided by some embodiments herein.

### BRIEF DESCRIPTION OF THE DRAWINGS

FIG. 1 is an illustrative depiction of a procurement process.

FIG. 2 is a block diagram of a system according to some embodiments.

FIG. 3 is an illustrative depiction of a networked business object according to some embodiments.

FIG. 4A is a simplified diagram of a networked business object according to some embodiments.

FIG. 4B is an illustrative depiction of the networked business object of FIG. 4A, including an additional state according to some embodiments.

FIG. 5 is a flow diagram of a process according to some embodiments.

FIG. 6 is a diagram of a system according to some embodiments.

FIG. 7 is a block diagram of a device according to some embodiments.

### DETAILED DESCRIPTION

As an introduction to embodiments of the present disclosure, a conventional procurement process will be introduced to highlight an example of some of the problems and a use case providing motivation for the embodiments herein. Those skilled and knowledgeable in the arts related to business processes will understand that some characteristics of the procurement process example may also exist in a great many of other business processes. Accordingly, embodiments herein are not limited to a procurement process or environment.

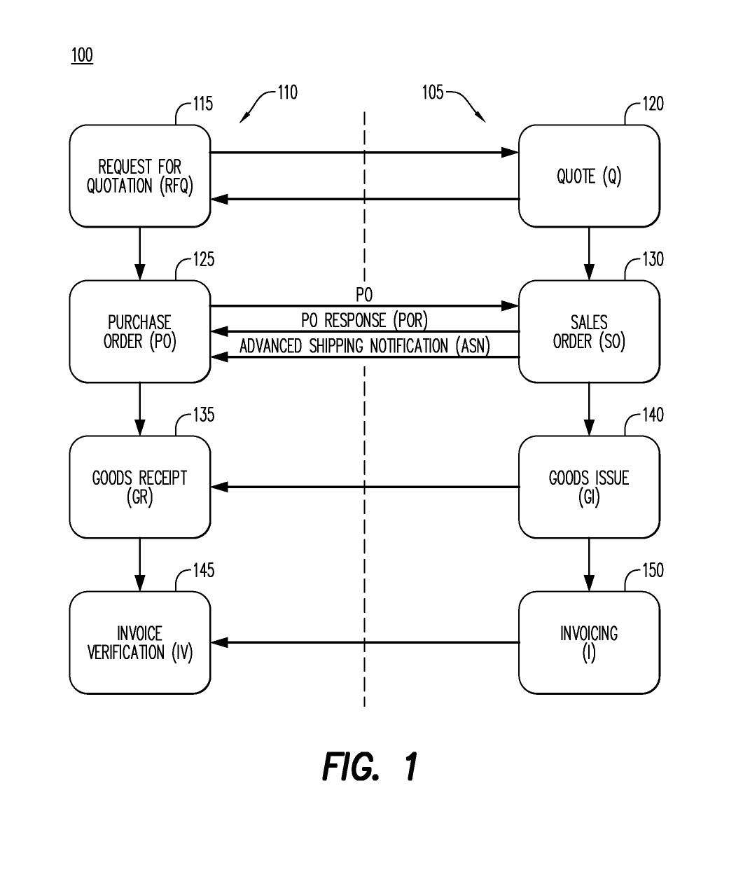

FIG. 1 is an illustrative depiction of a process 100 involving an interaction and exchange of data between entities. Process 100 represents a conventional procurement process, including the exchange of multiple documents between, for example, a vendor 105 on a supplier side and a customer 110 on a buyer side. Process 100 may encompass a number of stages as process 100 proceeds from a request for quotation (RFQ) stage to an invoicing (I) stage. In a typical sequence of events, customer 110 may issue a RFQ 115 document to vendor 105 regarding a product or service. In reply, vendor 105 may provide a quote (Q) document 120 that includes, for example, a price and schedule for the vendor to deliver the subject product or service. In a next stage of process 100, customer 110 generates a purchase order (PO) 125 that is sent to vendor 105. Vendor 105 generates a sales order (SO) and may provide a purchase order response (POR) and an advanced shipping notification (ASN) to the customer regarding the subject product or service. Continuing with process 100, vendor 105 may next provide the agreed upon product or service to customer 110, with the issuance of the goods reflected in a goods issue (GI) 140 document. Complimentary to GI 140, customer 110 may generate a goods receipt (GR) 135 document that reflects the customer's receipt of the goods from the vendor. Process 100 may then proceed to an invoicing stage where vendor 105 generates and issues an invoice (I) 150 to customer 110. Customer 110 may produce an invoice verification (IV) 145, which acknowledges and confirms the invoice from the vendor is accurate and acceptable. It should be appreciated that process 100 is an illustrative example of a procurement process, where additional, fewer, and alternative operations other than those specifically shown in FIG. 1 may be included in the process.

It is noted that PO 125 and SO 130 may, in large part, contain some of the same data since they relate to a same stage of the procurement process. However, PO 125 and SO 130 are separate and distinct documents generated and maintained by different entities, each having their own identifiers and configured according to requirements and preferences of their respective owners. In a similar manner, the other documents related to each of the stages of procurement process 100 may also contain, to an extent, some of the same data or content as other documents related to the procurement process. For example, RFQ 115 and Q 120 may include a number of terms and conditions that are the same. However, customer 110 may generate and maintain RFQ 115 in its computer systems whereas vendor 105 generates and maintains Q 120 in its own computing system. Accordingly, procurement process 100 may involve the exchange of numerous documents and data records, with at least some of those documents and records including data contained in other documents and records also associated with the procurement process.

Vendor 105 and customer 110 may, in some instances, connect to each other via a communication network (not shown) to exchange the many different documents (e.g., 115-150). Even when and/or where vendor 105 and customer 115 connect with each in fulfillment of process 100, the numerous different documents each need to be separately agreed upon, generated, maintained, and then transmitted between the entities. Process 100 is an illustrative example involving only one vendor 105 and one customer 110. The complexity and resources required to implement process 100 may increase as the number and/or scope of the involved entities increases.

The documents of process 100 may each be represented as a business object, where the business object is an instance of a meta model business object class or type. In some aspects and contexts, the business object (BO) may represent a business relationship, process, or entity. A BO may specify business logic and/or data and/or methods having any suitable structure. The structure of a business object may be determined based on the requirements of a business scenario in which the BO is to be deployed. A business solution for a particular business scenario may include many business objects (BOs), where the structure of each BO has been determined based on the requirements of the particular business scenario. The BO may represent real-world items (e.g., data files, records, documents, etc.) of a business transaction or process (e.g. procurement process 100) such as, for example, PO 125, SO 130, and I 150, as well as the other documents and data actions shown in FIG. 1. A particular data set according to the data structure defined by a BO type is an instantiation of the BO. Accordingly, PO 125, SO 130, and I 150 are each BO instantiations of the BO type or class. It is noted that other types of business items may be represented by a BO, including those not specifically shown in FIG. 1.

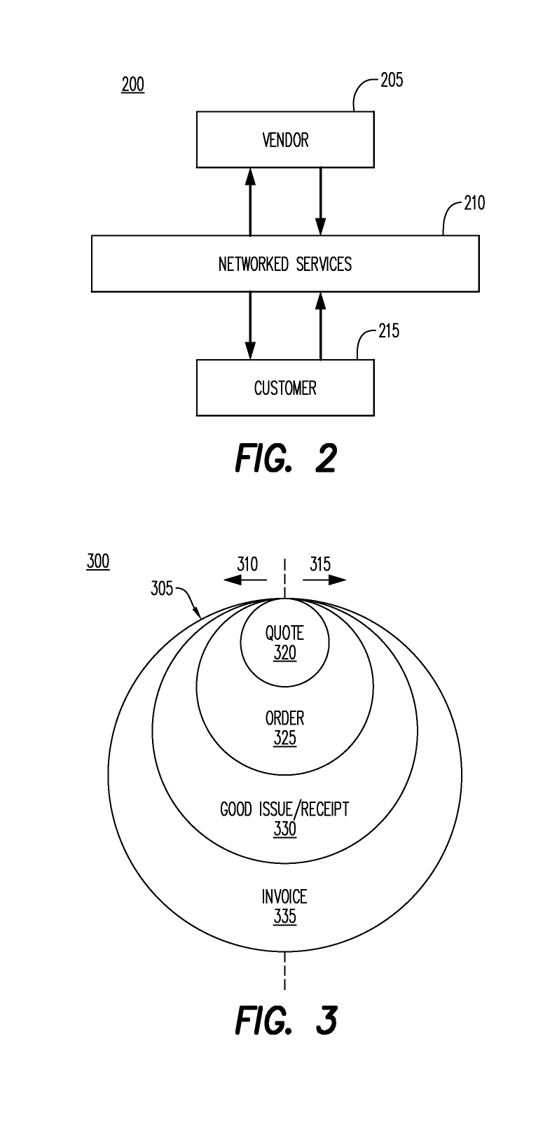

FIG. 2 is a block diagram of a system 200 according to some embodiments herein. System 200 may include a first entity 205 and a second entity 215 that are networked and connected to each other via networked services 210. Entities 205 and 210 may be business partners engaged in a business transaction or relationship. System 200 may be implemented and/or facilitated by an ever-increasing connectivity of business partners in a real-world business environment. Continuing the procurement process example of FIG. 1, the first entity of FIG. 2 is a vendor 205 and the second entity is a customer 215. While the connectivity depicted in FIG. 2 may offer some increased enchantment(s) for a process such as, for example, process 100, networked services 210 may include a procurement service that leverages the networked connectivity of vendor 205 and customer 215 in some embodiments herein. Networked services 210 may be provided, facilitated, or supported by a cloud service, software as a service (SaaS), and other implementations. In some embodiments, a communication network of system 200 may include an on-demand private cloud, whereas some instances of the network may include a public network. In some embodiments, some networks may include email, social networks, chat forums, the Internet, etc.

FIG. 3 is a logical depiction of a new meta model 300 that may facilitate business processes in a networked environment. In some embodiments, meta model 300 may be referred to as a networked business object (n-BO). Meta model 300 may include a particular n-BO 305. In some aspects, n-BO 305 reflects a business process. In particular, n-BO 305 may reflect, for example, a procurement process including multiple aspects of a procurement process from a quote to an invoice, where the procurement process relates to a vendor 315 and a customer 310. Accordingly, a single n-BO may reflect a process comprising multiple steps (e.g., sub-processes) or stages that may be shared between different networked entities (e.g., vendor 315 and customer 310).

In some aspects, the single n-BO 305 data structure may be defined to “evolve” from a quote to an invoice, including the intervening stages of the procurement process. In some embodiments, an n-BO comprises a plurality of states, where each state reflects and represents a distinct stage or level of the business process reflected by the n-BO. For example, n-BO 305 includes a Quote state 320. Quote state 320 may include attributes typically associated with a RFQ and a Quote. In some embodiments, n-BO 305 may include some attributes found in a conventional PO and SO of FIG. 1, but since only one data structure is shared in a networked connectivity context in some embodiments, the attributes of n-BO 305 may not necessarily correspond to the conventional PO and SO since redundancies may be reduced and separate documents and data records need not be generated and maintained for a n-BO. For example, n-BO 305 may be identified by a single reference identifier name and/or number, thereby eliminating a need for separate PO and SO identifiers. In general, all of the states of a n-BO may be represented by a single identifier that references the n-BO and all of the states belonging to the n-BO. In some aspects, all stages of the procurement process may be referenced by n-BO 305 using the same common identifier for the n-BO. N-BO 305 may also include an Order state 325, a Goods Issue/Receipt state 330, an Invoice state 335, and other states (not shown).

In some embodiments, n-BO 305 may provide a mechanism (i.e., a data structure) that facilitates collaborative processes wherein multiple entities may share and work on the same data structure, n-BO 305. The networked entities may have shared access to the common data structure, the n-BO, and the data referenced thereby. In this manner, the multiple entities having networked access to the n-BO need not exchange documents, including but not limited to different copies or versions of a document. Instead, the single network accessible n-BO reflecting a business process may be maintained in the cloud and accessed on-demand by the networked entities interacting with each other and the n-BO.

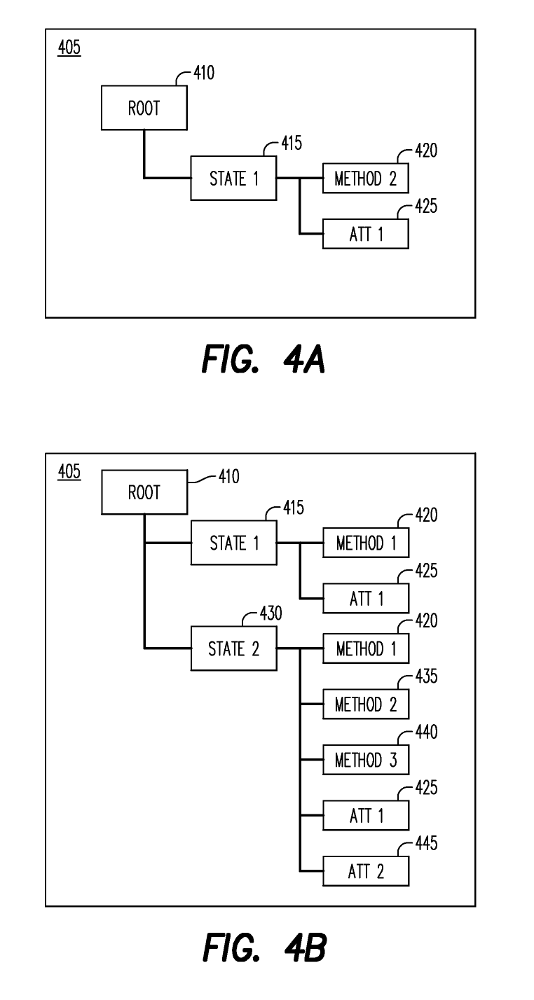

FIG. 4A is an illustrative depiction of a n-BO 405, in accordance with some embodiments herein. In this example, n-BO 405 includes two nodes, a root node 410 and node 415, state 1. Each of the nodes of n-BO may have a number of attributes defining the data requirements of the n-BO. For example, attributes for Quote state 320 may include a “name” field for a vendor, an “address” field for the vendor's address, and a “price” field. Other attribute fields may also be associated with Quote state 320. In some embodiments, one or more methods or actions may be associated with n-BOs herein. In the example of FIG. 4A, a method 1 (420) is defined and associated with the particular n-BO 405, state 1 (415) depicted therein. Additionally, an attribute “ATT 1” (425) is also defined and associated with n-BO 405.

In some embodiments, metadata associated with n-BO 405 may include information defining the structure, attributes, and methods of the n-BO object model. Accordingly, the metadata may include the definitions for the attributes and methods associated with each state of the n-BO, as well as the relationships between the nodes of the n-BO and relationships (e.g., dependencies, uses, etc.) of the n-BO with other data structures (e.g., other n-BOs and other data structures). The metadata may be, for example, an extensible markup language. In this regard, n-BO 405 is a meta model class or type. In some embodiments, n-BOs instances herein may be generated in a run-time environment and persisted in a metadata repository or data store.

FIG. 4B is another depiction of n-BO 405. The n-BO 405 of FIG. 4B comprises a different state than state of the n-BO 405 depicted in FIG. 4A. Although the same n-BO 405 is depicted in FIGS. 4A and 4B, the state of the n-BO in each of the FIGS. 4A and 4B is different and distinct from each other. Accordingly, the attributes and methods of the n-BO in FIGS. 4A and 4B are different, as reflected in the difference in nodes shown in FIGS. 4A and 4B. FIG. 4B may reflect Order state 325 introduced in FIG. 3. Order state 325 includes more attributes than the logically lower Quote state 320. The increased number and/or types of attributes and methods of Order state 325 may be based, at least in part, on an order related to the procurement process reflected by n-BO 300 and 405 including more detailed data and actions than a quote.

In some aspects, Order state 325 may logically be viewed as a higher level state than Quote state 320. In some embodiments, a logically higher level state includes all of the attributes and methods of a logically lower level state. As shown, n-BO 405 of the state shown in FIG. 4B includes 3 nodes (i.e., root node 410; state 1 node 415, and state 2 node 430). Additionally, n-BO 405 of the state depicted in FIG. 4B includes a number of methods, namely method 1 (420), method 2 (435), and method 3 (440). The methods may be operations defined for and available for execution by the n-BO. Like attributes, metadata may be used to define and describe the methods of the n-BO. Additionally, attributes “ATT 1” (425) and “ATT 2” (445) are also defined and associated with the n-BO 405 depicted in FIG. 4B.

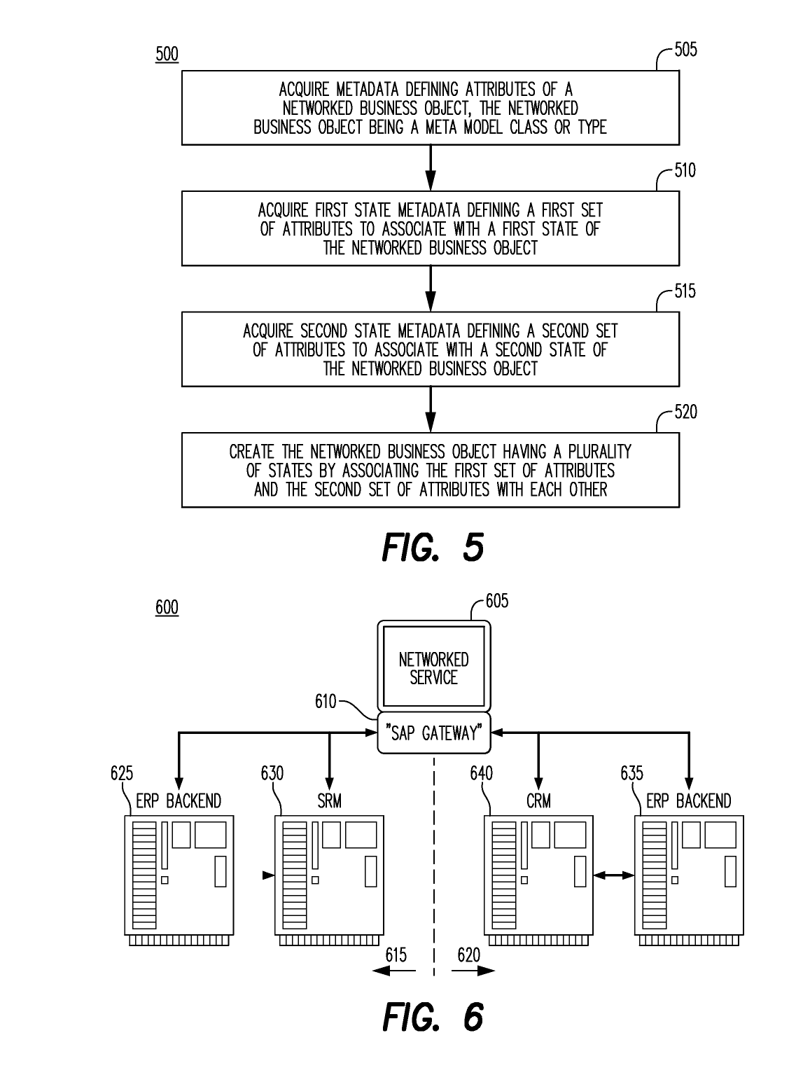

FIG. 5 is a flow diagram of a process 500, in accordance with some embodiments herein. In some aspects, process 500 may be related to a process of defining a n-BO meta model data structure having a plurality of states. At operation 505, metadata describing an object model with n-BO root note description, possible states, state related possible attributes and methods (including, in some aspects, interfaces as special kind of methods to invoke certain n-BO encapsulated methods) to be established and defined is acquired. The metadata may be acquired during a design time of a software development process or project from a developer via a user interface of a software development tool, program, or service. Operation 505 may be accomplished, in some embodiments, in one or more steps. Process 500 illustrates multiple steps, 510 and 515, for acquiring the metadata defining the n-BO being established by process 500. It is noted that the depiction of the metadata acquiring aspects of process 500 in the two steps of 510 and 515 is not limited to two discrete or separate operations. Operations 510 and 515 may be accomplished, in some embodiments, in fewer, greater, or an alternative number of steps.

Continuing to operation 510, first state metadata defining a first set of attributes and methods to associate with a first state of the n-BO being defined are acquired. As an example, the first state metadata of operation 510 may include the metadata to define the attributes of n-BO 405 of the state depicted in FIG. 4A. In some embodiments, the “first” state metadata is not limited to any particular state of the n-BO, whether a first state or any other state. The term “first” is used here to distinguish between different states, not a particular state per se.

Operation 515 includes acquiring second state metadata defining a second set of attributes and methods to associate with a second state of the n-BO being defined. For example, the second state metadata of operation 515 may include the metadata to define the attributes of n-BO 405 having the state depicted in FIG. 4B. As illustrated in FIG. 4B, the attributes of that second state of n-BO 405 include all of the attributes and methods of the first state (i.e., n-BO of FIG. 4A), as well as additional attributes and methods. Hereto, the “second” state metadata is not limited to any particular state of the n-BO, second or otherwise, but instead is used to refer to different states of the n-BO.

Process 500 may continue to operation 520, where the n-BO meta model (i.e., a data structure) having a plurality of the states is created. The n-BO meta model (i.e., a data structure) having a plurality of states may be created by associating the plurality of sets of attributes and methods acquired at operations 510 and 515 with each other. For example, the n-BO may be created by associating both the first set of attributes and methods corresponding to the first state of the n-BO and the second set of attributes and methods corresponding with the second state of the n-BO with each other. In some embodiments, operations 510 and 515 may be repeated until all of the plurality of states of the n-BO are defined by acquiring the requisite metadata.

FIG. 5 relates to the defining and establishment of a n-BO data structure, including the metadata defining the different states of the n-BO. The different states of the n-BO may each relate to a stage or level of a business relationship reflected by the n-BO, where the n-BO (e.g., Order n-BO of FIG. 3) may evolve from one state (e.g., Quote state 320) to another state (e.g., Order state 325). In some embodiments, all of the states of a n-BO may be defined as meta data in object classes at design time.

In some aspects, instantiation n-BOs herein may occur during run-time (e.g., at an initialization or evolvement of an n-BO instance from one state to the next) of a service or program, with the set of data (e.g., values for the defined methods and attributes) corresponding to the states of the n-BO being specified (i.e., instantiated) during the run-time.

Some aspects of the meta model class of embodiments herein have been described in the context of, primarily, a procurement process. For example, n-BO relates to and captures various aspects of a procurement process but not limited to. It is noted that embodiments of the n-BOs object model herein may relate to or reflect different types of data and logic. For example, n-BO types may, in general and without limit, be defined and created for (1) an entity such as a Business Partner, (2) an Order, (3) an Item (4) a Project, and (5) a Document. The Business Partner type n-BO may reflect data associated with a business contact, company or other entity, including the contact's position, skills, responsibilities, business functions, etc. Representing data associated with a business partner as an n-BO may be advantageous since a business partner's “footprint” in a business scenario may evolve over time as the business partner's activities and/or status and responsibilities evolve. The Order type of n-BO may include contractual based business relationships such as, for example, the procurement process reflected in n-BO 305. The Item type of n-BO may be related to and reflect an article, product, material, retail item, stock keeping unit (SKU) or service, where the item characteristics defined by the n-BO may change (i.e., evolve) over time. The Project type of n-BO may include one particular project or a program as an aggregation of similar projects, where a project may include timelines, activities, persons and other resources designated to accomplish the activities goals. This type of n-BO may also relate to an evolving process since the status of the project will change over time. The Document type of n-BO may refer to any type of un-structured (i.e., text files or graphics) and semi-structured data. Herein, semi-structured data may refer to a document or other record that includes data that is not strictly formatted to or represented by a table or other data model constraints but may include some tags or delimiters to separate elements of the data and add some structure to the data. While five general n-BO types are introduced herein, the present disclosure is not limited thereto.

In some embodiments, n-BOs herein are suitable for representing both structured and semi-structured data and to some extend un-structured document data as described above. In some aspects, both structured and semi-structured data may be effectively represented by n-BOs in some embodiments, where collaborative access to the data is beneficial and the data reflected by the n-BOs may evolve from one state to another state.

FIG. 6 is an illustrative diagram of a system 600, in accordance with some embodiments herein. In some embodiments, system 600 may facilitate and support the use and implementation of n-BOs herein. System 600 includes a networked service 605 that connects to a number of other entities (e.g., customer 615 and vendor 620, and systems and devices related thereto) via a communications gateway 610. In some embodiments, networked service 605 and communication gateway 605 may be provided by the assignee of the present disclosure, SAP AG. Networked service 605 may be provided as an on-demand network accessed service, with n-BOs associated with the service provided and maintained as a Software as a Service (SaaS) or Platform as a Service (PaaS) through “cloud” computing. In this manner, the n-BOs of the networked service may be accessed and shared by various users connected to each other through the network of system 600.

In some embodiments, system 600 may be a system for facilitating and supporting n-BOs related to a networked procurement service but not limited thereto. In the example of FIG. 6, networked service 605 may include n-BOs reflecting one or more n-BOs related to a procurement process, such as but not limited to the procurement processes specifically disclosed herein. In some aspects, data may exist in the “cloud”, as defined by embodiments of the n-BO data structure disclosed herein and persisted as specific instantiations of the n-BOs. While the data may exist in the “cloud” as n-BOs, it may be integrated into backend systems and devices of customer 615 and vendor 620. In some embodiments, backend systems and devices of customer 615 and vendor 620 may include, for example, a customer or buyer ERP (Enterprise Resource Planning) backend system (e.g., a server) 625 and a vendor or supplier ERP backend system 635 for receiving buyer's and supplier's financial data, respectively. As illustrated in FIG. 6, additional systems and devices such as customer SRM (Supplier Relationship Management) system 630 and vendor CRM (Customer Relationship Management) system 640. In some aspects, the backend systems of FIG. 6 may include existing or legacy systems and devices, while in some instances the backend systems may include future developed and deployed systems and devices.

In some embodiments, n-BOs and the data associated therewith may be downloaded to the backend systems (e.g., 625 and 635) for integration with those systems. However, in accordance with some aspects of embodiments of the n-BOs disclosed herein, a single networked procurement n-BO associated with networked service 605 may reflect a plurality of states of the procurement process. Accordingly, the single n-BO comprising (1) evolutionary aspects by virtue of the different states belonging to the n-BO, and (2) joint collaborative aspects wherein data shared by networked entities (e.g., the customer and the vendor) are included in the same n-BO, may be sent to the backend systems (e.g., 625 and 635) for integration therewith. In this manner, there is no need to exchange multiple different documents and other types of data between the vendor and the customer.

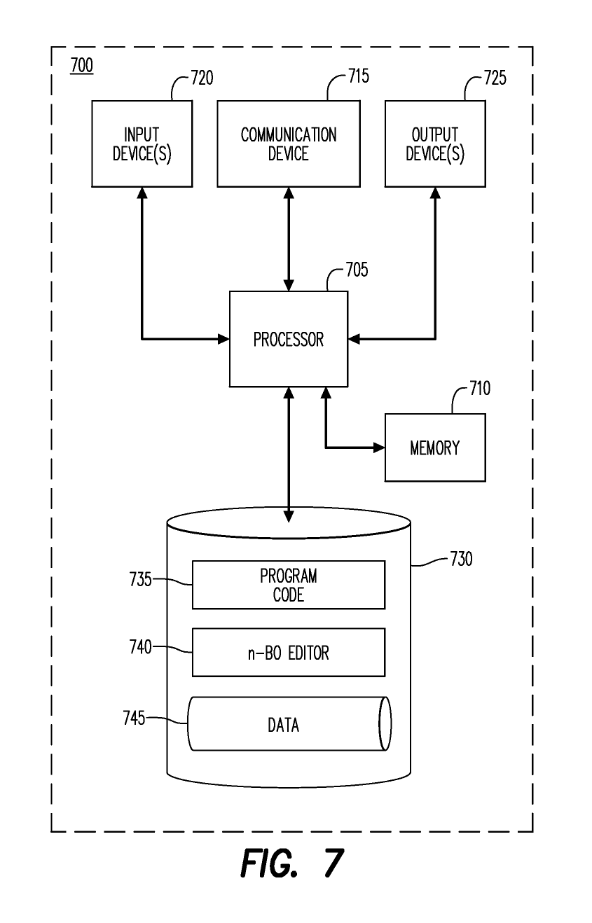

FIG. 7 is a block diagram overview of a system or apparatus 700 according to some embodiments. System 700 may be, for example, associated with any of the devices described herein, including for example a server for supporting networked service 605. In some embodiments, system 700 may include a system for designing and defining n-BOs, as used by, for example, a software developer. System 700 comprises a processor 705, such as one or more commercially available Central Processing Units (CPUs) in the form of one-chip microprocessors or a multi-core processor, coupled to a communication device 715 configured to communicate via a communication network (not shown in FIG. 7 to another device or system. In the instance system 700 comprises an application server, communication device 715 may provide a means for system 700 to interface with a client device (e.g., an entity connected to a networked service in an on-demand environment). System 700 may also include a local memory 710, such as RAM memory modules. System 700 further includes an input device 720 (e.g., a touch screen, mouse and/or keyboard to enter content) and an output device 725 (e.g., a computer monitor to display a user interface element).

Processor 705 communicates with a storage device 730. Storage device 730 may comprise any appropriate information storage device, including combinations of magnetic storage devices (e.g., a hard disk drive), optical storage devices, and/or semiconductor memory devices. In some embodiments, storage device may comprise a database system.

Storage device 730 stores a program code 735 that may provide computer executable instructions for processing requests from, for example, client devices in accordance with processes herein. Processor 705 may perform the instructions of the program 735 to thereby operate in accordance with any of the process embodiments described herein. Program code 735 may be stored in a compressed, uncompiled and/or encrypted format. Program code 735 may furthermore include other program elements, such as an operating system, a database management system, and/or device drivers used by the processor 705 to interface with, for example, peripheral devices. In some embodiments, storage device 730 may include program instructions or code to facilitate and support an n-BO editor 740. The n-BO editor 740 may provide a mechanism for a developer to enter, manipulate, and otherwise edit metadata defining attributes and methods of an n-BO. Storage device 730 may also include data 745. Data 745 may be used by system 700, in some aspects, in performing the processes herein, such as process 500. In some embodiments, storage device 730 may comprise a database management system or aspects thereof. In some aspects, storage device 730 may store a n-BO object model, an instantiation of the n-BO (i.e., the data referenced by a particular instance of the n-BO), and other data types.

Each system and device described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a flash drive, a hard disk drive, a CD-ROM, a DVD-ROM, magnetic tape, and solid state RAM (main memory, also known as in-memory) or ROM memories. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A computer-implemented method executed by a processor of a computer, the method comprising:
acquiring metadata defining attributes of a networked business object, the networked business object being a meta model class or type data structure and the acquiring comprising:
acquiring first state metadata defining a first set of attributes to associate with a first state of the networked business object;
acquiring second state metadata defining a second set of attributes to associate with a second state of the networked business object; and
creating the networked business object having a plurality of states by associating the first set of attributes and the second set of attributes with each other.

2. The method of claim 1, wherein each of the plurality of states of the networked business object comprises a distinct set of attributes and methods.

3. The method of claim 1, further comprising:
acquiring additional state metadata defining additional sets of attributes and methods to associate with other states of the networked business object; and
associating the additional sets of attributes and methods with the networked business object having the plurality of states.

4. The method of claim 1, wherein the first state metadata and second state metadata are logically ordered relative to each other.

5. The method of claim 4, wherein a higher ordered state metadata includes all of the attributes and methods of a lower ordered state metadata.

6. The method of claim 1, further comprising associating at least one method with at least one of the first state metadata and the second state metadata, the created networked business object comprising the plurality of states with the at least one method being associated with the plurality of states.

7. The method of claim 1, wherein the first set of attributes and methods and the second set of attributes and methods include structured data, semi-structured data, and combinations thereof.

8. The method of claim 1, wherein the networked business object logically represents a business process, with the plurality of states of the networked business object each reflecting a sub-process of the business process.

9. The method of claim 1, wherein the networked business object logically represents an entity, with the plurality of states of the object model each reflecting a different stage of development of the entity.

10. The method of claim 1, further comprising:
generating an instance of the networked business object by associating specific data, in accordance with the data structure specified by the networked business object; and
persisting the instance of the networked business object by storing the specific data associated with the networked business object in a data storage device.

11. The method of claim 1, further comprising permitting shared access to the networked business object by at least one networked business entity.

12. The method of claim 1, further comprising associating a single identifier with the networked business object to reference the networked business object and the plurality of states of the networked business object.

13. A medium having program instructions stored thereon, the medium comprising:
instructions to acquire metadata defining attributes of a networked business object, the networked business object being a meta data model class or type data structure and the acquiring comprising:
instructions to acquire first state metadata defining a first set of attributes to associate with a first state of the networked business object;
instructions to acquire second state metadata defining a second set of attributes to associate with a second state of the networked business object; and
instructions to create the networked business object having a plurality of states by associating the first set of attributes and the second set of attributes with each other.

14. The medium of claim 13, wherein each of the plurality of states of the networked business object comprises a distinct set of attributes and methods.

15. The medium of claim 13, further comprising:
instructions to acquire additional state metadata defining additional sets of attributes and methods to associate with other states of the networked business object; and
instructions to associate the additional sets of attributes and methods with the networked business object having the plurality of states.

16. The medium of claim 13, wherein the first state metadata and second state metadata are logically ordered relative to each other.

17. The medium of claim 16, wherein a higher ordered state metadata includes all of the attributes of a lower ordered state metadata.

18. The medium of claim 13, further comprising instructions to associate at least one method with at least one of the first state metadata and the second state metadata, the created networked business object comprising the plurality of states with the at least one method being associated with the plurality of states.

19. The medium of claim 13, wherein the first set of attributes and the second set of attributes include structured data, semi-structured data, and combinations thereof.

20. The medium of claim 13, wherein the networked business object data structure logically represents a business process, with the plurality of states of the object model each reflecting a sub-process of the business process which follow each other in an evolutionary way.

21. The medium of claim 13, wherein the networked business object data structure logically represents an entity, with the plurality of states of the object model each reflecting a different stage of development of the entity.

22. The medium of claim 13, further comprising:
instructions to generate an instance of the networked business object by associating specific data, in accordance with the data structure specified by the networked business object meta model; and
instructions to persist the instance of the networked business object by storing the specific data associated with the networked business object in a data storage device.

23. The medium of claim 13, further comprising permitting shared access to the networked business object by at least one networked business entity.

24. The medium of claim 13, further comprising associating a single identifier with the networked business object to reference the networked business object and the plurality of states of the networked business object.
